(19) United States
(12) Patent Application Publication
(10) Pub. No.: US 2026/0072715 A1
(43) Pub. Date: Mar. 12, 2026

(54) ENHANCED POWER GRID CONTAINERIZED INTELLIGENT ELECTRONIC DEVICE DISCOVERY FOR REMOTE AUTO-PROVISIONING

(71) Applicant: GE Infrastructure Technology LLC, Greenville, SC (US)

(72) Inventors: Balakrishna PAMULAPARTHY, Hyderabad (IN); Darren James WEBB, Stafford (GB); Zhi ZHAO, Markham (CA)

(73) Assignee: GE Infrastructure Technology LLC, Greenville, SC (US)

(21) Appl. No.: 18/830,027

(22) Filed: Sep. 10, 2024

(51) Int. Cl. G06F 9/455; G06F 8/65; G06F 21/53; H04L 67/51

(52) U.S. Cl. CPC G06F 9/455; G06F 8/65; G06F 21/53; H04L 67/51

(57) ABSTRACT

Devices, systems, and methods for automatically provisioning containerized intelligent electronic devices (IEDs) of a grid network include identifying, by a device management system, basic details of a containerized IED provided by the containerized IED; determining, based on the basic details, that the containerized IED is running in the network; identifying, based on the basic details, a secure login for the containerized IED; sending a secure login request to the containerized IED based on the secure login; receiving, based on the secure login request, advanced details of the containerized IED provided by the containerized IED; identifying, based on the advanced details, an upgrade available to an application of the containerized IED; instruct a backup virtual machine of the containerized IED to run the upgraded application; and monitoring new upgrades and applications available for containerized IEDs in the network.

### TECHNICAL FIELD

This disclosure generally relates to power grid management, and more particularly to an intelligent electronic device discovery technique for remote auto-provisioning.

### BACKGROUND

Intelligent electronic devices (IEDs) are computerized protection devices and controllers of power system equipment. A container-based IEDs runs in an application in a server or as a virtual machine, and provide flexibility and computing power to applications of power grids.

### SUMMARY

A method for automatically provisioning intelligent electronic devices (IEDs) in a network may include: identifying, by at least one processor of a device management system, basic details of a containerized IED provided by the containerized IED; determining, by the at least one processor, based on the basic details, that the containerized IED is running in the network; identifying, by the at least one processor, based on the basic details, a secure login for the containerized IED; sending, by the at least one processor, a secure login request to the containerized IED based on the secure login; receiving, by the at least one processor, based on the secure login request, advanced details of the containerized IED provided by the containerized IED; identifying, by the at least one processor, based on the advanced details, an upgrade available to an application of the containerized IED; generating, by the at least one processor, a temporary virtual machine of the containerized IED with which to upgrade the application; sending, by the at least one processor, the upgrade to the temporary virtual machine; and monitoring, by the at least one processor, the containerized IED for additional upgrades.

An asset management system for a grid network, the asset management system comprising memory coupled to at least one processor, wherein the at least one processor is configured to: identify basic details of a containerized intelligent electronic device (IED) provided by the containerized IED; determine, based on the basic details, that the containerized IED is running in the network; identify, based on the basic details, a secure login for the containerized IED; send a secure login request to the containerized IED based on the secure login; receive, based on the secure login request, advanced details of the containerized IED provided by the containerized IED; identify, based on the advanced details, an upgrade available to an application of the containerized IED; generate a temporary virtual machine of the containerized IED with which to upgrade the application; send the upgrade to the temporary virtual machine; and monitor the containerized IED for additional upgrades.

A non-transitory computer-readable medium storing instructions that, when executed by at least one processor of an asset management system for a grid network, cause the at least one processor to: identify basic details of a containerized intelligent electronic device (IED) provided by the containerized IED; determine, based on the basic details, that the containerized IED is running in the network; identify, based on the basic details, a secure login for the containerized IED; send a secure login request to the containerized IED based on the secure login; receive, based on the secure login request, advanced details of the containerized IED provided by the containerized IED; identify, based on the advanced details, an upgrade available to an application of the containerized IED; generate a temporary virtual machine of the containerized IED with which to upgrade the application; send the upgrade to the temporary virtual machine; and monitor the containerized IED for additional upgrades.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for automatically provisioning containerized intelligent electronic devices (IEDs) in a grid network in accordance with one embodiment of the present disclosure.

FIG. 2 illustrates an example process for automatically provisioning containerized IEDs in a grid network in accordance with one embodiment of the present disclosure.

FIG. 3 illustrates an example system for automatically provisioning containerized IEDs in a grid network in accordance with one embodiment of the present disclosure.

FIG. 4 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Devices of power transformers, such as relays, switches, transformers, circuit breakers, and the like, may be processor-controlled as intelligent electronic devices (IEDs). IEDs can be hardware-based or container-based. A container-based IEDs runs in an application in a server or as a virtual machine, and provide flexibility and computing power to applications of power grids. In the future, container-based IEDs may be installed in power substations. Applications inside of a container may update, change applications versions, and modify any settings.

When an IED is added to a grid network, grid management systems need to be able to detect the IED. Automatic detection of IEDs, particularly remote detection of the IEDs, is challenging.

For example, after a hardware-based IED is configured in a grid network (e.g., by loading firmware into the IED), it may be desirable to update the firmware at some point. Such updates are difficult and sometimes undesirable to users (e.g., because the update may affect operations). In addition, it may be beneficial to add a new application to the IED. Adding a new application to the IED may require adding new firmware to the IED and testing the new firmware on the IED. Similarly, to modify any feature or application in IED firmware, additional firmware may need to be uploaded to the IED. However, these updates, additions, and modifications may be simplified with containerized IEDs in comparison to hardware-based IEDs.

Grid smart electrical loads, renewable energy generation, energy storage and communications and control hubs-based configuration service provider (CSP) devices need to access the upstream grid device management client for continuous upgrades. Grid edge monitoring and control software modules in CSP-based devices need continuous upgrade/addition of software for managing complex applications like distributed energy resources and their participation in the wider grid and market.

The present disclosure provides automatic provisioning of containerized IEDs in a power network, automatic upgrades to applications running in a containerized IED, and automatic addition of new applications and features on top of an existing containerized IED applications and features. As grid networks continue growing, more control points and IEDs are added, so centralized control of many disparate IEDs for grid networks is becoming more challenging. The present disclosure addresses these challenges.

The enhanced techniques herein provide plug-play connection (e.g., registration) and updates, grid edge control interface for scheduling, dispatch, visibility and data collection, an integration point for grid assets, delivery of schedule control (e.g., to owner, OEM or utility schedule), delivery of setpoint control over multiple asset types, interface and protocol options to control systems, monitoring of site P, Q, voltage and frequency, standalone local control and remotely managed controls, integration of multiple onsite distributed energy resources in co-located and hybrid configurations, configurable scheduling, setpoint and fail-to-safe/fail-to-default/remediation actions, and a wide range of communications integration options.

In one or more embodiments, grid automation may ensure a stable, efficient energy supply amidst growing integration of renewable energy sources and legacy infrastructure. Enhanced automation techniques digitalize substations, manage grid zones autonomously, and remotely manage devices and communication networks. The enhanced techniques herein apply to the remote management of devices portion of grid automation solutions. The enhanced remote management techniques herein may increase visibility across a fleet, even down to a secondary asset level.

In one or more embodiments, a device management system (e.g., for managing IEDs of a grid network) may receive notifications when a new device (e.g., IED) is connected to the network, and may automatically provision the device. When a new device connects to the network, the system may discover the device using techniques such as Dynamic Host Configuration Protocol (DHCP) or Address Resolution Protocol (ARP), for example. These techniques may allow the system to identify new devices and obtain their unique identifiers, such as medium access control (MAC) addresses or serial numbers. Once the new device is identified, the device may register with a device management platform of the system. For example, a device's unique identifier and/or other relevant device information may be used to generate a profile for the device in the management platform. Based on the device profile and predefined rules, the device management platform may assign appropriate policies, settings, and configurations to the device, including network settings, security policies, application installations, and the like. The device management platform may push the assigned settings, policies, and configurations to the device over the network, and the device may apply the configurations automatically to complete the provisioning process. Once the device is provisioned, the device management platform may continuously monitor its status and update or modify the device's settings as appropriate. The process allows for seamless automatic provisioning of devices as soon as they connect to the network. A containerized device may be automatically discovered as a result, and the device's applications may be maintained, upgraded, and downloaded seamlessly without interrupting operations of the grid.

In one or more embodiments, a containerized IED may have basic (optionally encrypted) and advanced (encrypted) details incorporated in a shared memory access before the IED is shipped to a client. The basic details such as IP address, device type, unique identifier, and the like, may be published first by the IED for a device management system to identify the device type and the appropriate secure login mechanism to the IED (e.g., a combination of the basic details) and to decrypt the advanced details. Upon a successful login procedure by the device management system, the IED may publish the advanced details for the device management system to decrypt. By decrypting the advanced details, the management system may determine the application, algorithms and versions in each container, inter-dependencies between containers, container dependencies on memory access/shared resources, available containers to load new applications, communication mechanisms/protocols between containers, client subscriptions to IED containers, and the like.

In one or more embodiments, based on the decrypted advanced details, an auto-provisioning feature of the device management system estimates whether any algorithm the IED needs an update in any specific container with an understanding of what the impact would be on IED operations during an update or upgrade procedure. The device management system may notify a user about a decision to approve an IED upgrade of the application or loading of a new application to the IED. The device management system may auto-update an algorithm when there is no impact to device operations based on a user preference. The device management system may estimate an approximate upgrade time and use a backup virtual machine/container to perform operations for the IED until the primary virtual machine/container is upgraded.

IED service discovery can be challenging. In one or more embodiments, a distributed key-value cloud-based solution (e.g., etcd) or a multicast domain name server (mDNS) solution may be implemented to facilitate the discovery of IEDs in a network. When an IED activates, an application on the IED may register to a cloud-based server, such as by publishing a message with information such as IP address of the IED, port, system information (e.g., Operating System, version, machine type—virtual, architecture), IED capabilities (e.g., application instance identifiers, name, snmp, syslog, gacsp, version, etc.), configuration, application information, upgradable applications, and the like. The communication between the IED and the cloud-based database may be secure, such as SSL (secure sockets layer), TLS (transport layer security), etc. The cloud-based server may be a centralized server. A cloud-based client may identify running IEDs based on the registration data in the server, and may establish a secure connection with a running IED to verify the IED. After verification, the client may auto-provision the IED by upgrading a container (e.g., using role-based access control) and updating role-based access control configuration. In this manner, the IED service discovery may be virtualized. When using mDNS for IED service discovery, a preconfigured IED may register its information (e.g., as described above) to a mDNS register in a local network. A mDNS resolver in the same local network may be used by an asset management system to access the registered IED information from the mDNS resolver.

In one or more embodiments, the auto-provisioning of containerized IEDs may use the device management software to identify any running IEDs and send a broadcast message to any configuration service providers (CSPs). A client may forward the broadcast message to a centralized server, which may publish the broadcast message on a network. CSP devices may receive the broadcast message and respond by providing basic IED details to the server. The server may receive the basic IED details from the CSP devices, and the client may read the details from the server. The device management system may identify the CSP devices and their secure login mechanism based on the basic details provided. Then, the device management system may attempt a secure login to the CSP devices. The client may forward a secure login message to the server, which may publish the secure login message to be read by the CSP devices, which may validate the secure login message and respond by providing the advanced details to the server.

In one or more embodiments, all hardware-based IEDs may be consolidated into a single server, and all the IED applications may be run as virtual machines or containers to simplify centralized management of the IEDs. In this manner, a single server may manage many disparate IEDs in a grid network.

In addition, there has also been an increase in transmission-controllable node points and circuit configuration possibilities that have made centralized control challenging. Edge-based distributed intelligence requirements for grid networks are growing and enable intelligent, modular, and scalar solutions to centralized grid asset management. To provide distributed intelligence across IEDs in a grid network, the present disclosure provides modularity and scalability. The present disclosure also will reduce network latency, improve modeling accuracy and management controls, and increase real-time information by running grid network analytics at an edge device. Edge devices may perform grid network modeling because of analytics running at the edge, and edge devices have sufficient computing capability and processing power to remotely manage virtual IEDs of a grid network. The virtual IEDs need an innovative mechanism to manage applications running as containers through remote provisioning, which the present disclosure provides.

In one or more embodiments, the present disclosure provides an ability to auto-provision and upgrade IEDs with programmable and configurable containerized applications. In addition, the present disclosure allows for visualizing and managing a transmission grid as a set of containerized IED applications based on network topology. The enhanced techniques herein also provide proactive control actions for next operating intervals based on forecasting and zonal learning capabilities.

In one or more embodiments, the present disclosure provides a service discovery, a device connection and verification via a device management system, and an auto upgrade (e.g., provision) and configuration update without interrupting operation of grid assets.

In one or more embodiments, the remote provisioning of containerized IEDs herein may include multiple features. One feature is auto-provisioning (e.g., self-discovery), a process of creating and setting up a network of IEDs using a secure containerized infrastructure to support grid automation technologies in virtualization. Another feature is autonomy, allowing for upgrading containers for cybersecurity issues and new grid technologies in a grid automation domain to maintain reliability and availability of critical applications. Another feature is that the techniques are vendor-agnostic: use of a generic platform for grid edge automation systems may support containerization automation technologies for real-time systems.

In one or more embodiments, all IEDs may automatically publish in a network a discovery data packet that includes their basic device details in an encrypted manner (e.g., periodically). A service discovery mechanism in a client device may identify a containerized device in the network based on the discovery data packet (e.g., based on the header of the packet). The client may determine a secure login procedure for a containerized IED based on the basic information about the IED that is signaled in the discovery packet. The client may execute a secure login procedure for an IED and may retrieve advanced details from the IED based on the secure login. Based on the advanced details, the client may determine container details, interactions, algorithms, versions, type, memory access, and the like for a given IED. The client may determine whether there are any upgrades available to an application on the IED and may perform the upgrade based on the upgrade version availability and an operator setting (if enabled). The system also may automatically port the new application in the containerized IED based on the upgrade version availability and the operator setting when enabled. Real-time and non-real-time applications may be cloned to a temporary virtual machine/container with established links during application upgrades to ensure service continuity. A post-upgrade link between the original virtual machine/container and the temporary virtual machine/container may be established. The temporary virtual machine/container may be disabled upon completion of the upgrade.

The above descriptions are for purposes of illustration and are not meant to be limiting. Numerous other examples, configurations, processes, etc., may exist, some of which are described in greater detail below. Example embodiments will now be described with reference to the accompanying figures.

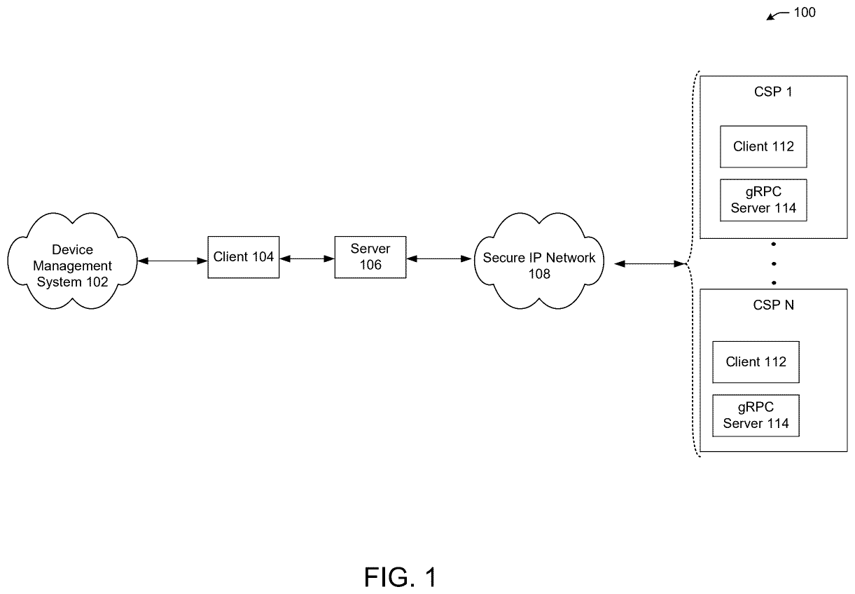

FIG. 1 illustrates an example system 100 for automatically provisioning containerized intelligent electronic devices (IEDs) in a grid network in accordance with one embodiment of the present disclosure.

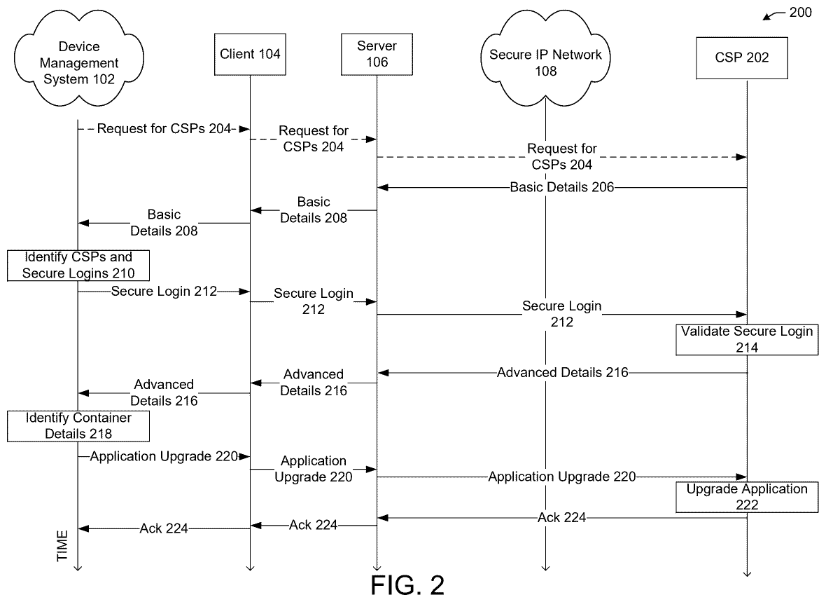

Referring to FIG. 1, the system 100 may include a device management system 102 (e.g., capable of auto-provisioning), a client 104 for the system 100, a server 106 (e.g., an ETCD server), a secure IP network 108, and CSPs 1-N (e.g., of one or more IEDs). The CSPs may be preconfigured with a client 112 (e.g., ETCD client) and a server 114 (e.g., gRPC server for remote procedure call framework) for an IED, its containers, applications, settings, and configurations. The IEDs may publish their basic details, which may be in response to an optional request broadcast by the device management system 102. Using the basic details, the device management system 102 may identify IEDs connected to the secure IP network 108 and their secure login information (e.g., using a device identifier of an IED). The device management system 102 may securely log into an IED using the secure login information, and as a result, an authenticated IED may provide its advanced details to the device management system 102. Based on the advanced details, the device management system 102 may identify any new applications or application upgrades to apply to the IED, along with any settings and/or configurations to push to the IED, and may push that information to the IED without disrupting grid network operations performed by the IED. A process for auto-provisioning using the system 100 is shown in FIG. 2.

FIG. 2 illustrates an example process 200 for automatically provisioning containerized IEDs in a grid network in accordance with one embodiment of the present disclosure.

Referring to FIG. 2, the device management system 102 of FIG. 1 optionally may broadcast a request 204 for CSPs (e.g., of one or more IEDs) connected to the secure IP network 108 and that are running so that the device management system 102 may identify them. The client 104 may forward the broadcast request 204 to the server 106, which may publish the broadcast request 204 on the secure IP network 108, where the IEDs 1-N of FIG. 1 (e.g., CSP 202) may receive the broadcast message. In response, the CSP 202 may provide its basic details 206, which the server 106 may receive via the secure IP network 108. The client 104 may read the basic details 206 from the server 106. As a result, the device management system 102 may identify 210 the CSP 202 and its secure login mechanism using the basic details 206. Based on the secure login mechanism, the device management system 102 may send a secure login request 212, which may be forwarded by the client 104 to the server 106, which may publish the secure login request 212 to be read by the CSP 202. The CSP 202 may validate 214 the secure login request 212, and once authenticated, the CSP 202 may provide its advanced details 216.

Still referring to FIG. 2, the server 106 may receive the advanced details 216 via the secure IP network 108. The client 104 may read the advanced details 216 from the server 106, and the device management system 102 may use the advanced details 216 to identify 218 container details of the CSP 202, such as containers, container dependencies, versions, applications, communications protocols, services, shared memory, and the like, and may identify any updates that may be performed at the CSP 202 without impacting operations performed by the CSP 202. When an application upgrade 220 is permitted at the CSP 202, the device management system 102 may provide the application upgrade 220, which the client 104 may forward to the server 106, which may publish the application upgrade 220. The CSP 202 may receive the application upgrade 220 via the secure IP network 108, and may automatically upgrade 222 the application without requiring user intervention. When the application is upgraded at the CSP 202, the CSP 202 may send an acknowledgement 224 (Ack) via the secure IP network 108, which may be retrieved at the server 106, read by the client 104, and processed at the device management system 102. The device management system 102 may continue to monitor the CSP 202 to determine whether additional upgrades are appropriate, following steps 220-224 as needed.

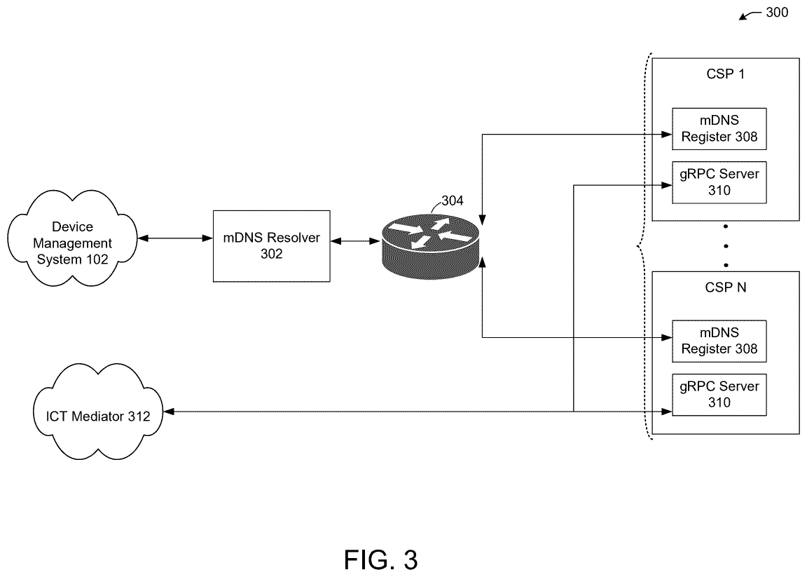

FIG. 3 illustrates an example system 300 for automatically provisioning containerized IEDs in a grid network in accordance with one embodiment of the present disclosure.

Referring to FIG. 3, the system 300 may use a mDNS resolver 302 and network router 304 with the device management system 102 of FIG. 1. CSP devices 1-N each may include a mDNS register 308 and a gRPC server 310 for a given gRPC service of a CSP. A preconfigured IED may register its information (e.g., as described above) to the mDNS register 308 in a local network. The mDNS resolver 302 in the same local network may be used by the asset management system 102 to access the registered IED information from the mDNS resolver 308. The network router 304 may use a TCP to communicate with the mDNS register 308. An ICT mediator 312 may use gRPC to communicate with the gRPC server 310. In contrast with the system of FIG. 1, no server is required in the system 300.

It is understood that the above descriptions are for purposes of illustration and are not meant to be limiting.

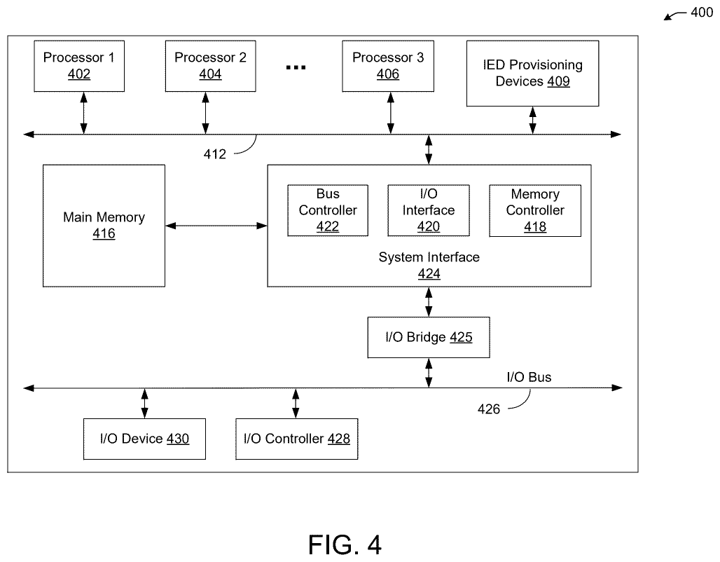

FIG. 4 is a diagram illustrating an example of a computing system 400 that may be used in implementing embodiments of the present disclosure.

The computer system 400 (system) includes one or more processors 402-406 and IED provisioning devices 409 (e.g., representing the device management system 102), capable of performing the IED auto-provisioning of FIGS. 1-3. Processors 402-406 may include one or more internal levels of cache (not shown) and a bus controller 422 or bus interface unit to direct interaction with the processor bus 412. Processor bus 412, also known as the host bus or the front side bus, may be used to couple the processors 402-406 with the system interface 424. System interface 424 may be connected to the processor bus 412 to interface other components of the system 400 with the processor bus 412. For example, system interface 424 may include a memory controller 418 for interfacing a main memory 416 with the processor bus 412. The main memory 416 typically includes one or more memory cards and a control circuit (not shown). System interface 424 may also include an input/output (I/O) interface 420 to interface one or more I/O bridges 425 or I/O devices with the processor bus 412. One or more I/O controllers and/or I/O devices may be connected with the I/O bus 426, such as I/O controller 428 and I/O device 430, as illustrated.

I/O device 430 may also include an input device (not shown), such as an alphanumeric input device, including alphanumeric and other keys for communicating information and/or command selections to the processors 402-406. Another type of user input device includes cursor control, such as a mouse, a trackball, or cursor direction keys for communicating direction information and command selections to the processors 402-406 and for controlling cursor movement on the display device.

System 400 may include a dynamic storage device, referred to as main memory 416, or a random access memory (RAM) or other computer-readable devices coupled to the processor bus 412 for storing information and instructions to be executed by the processors 402-406. Main memory 416 also may be used for storing temporary variables or other intermediate information during execution of instructions by the processors 402-406. System 400 may include a read only memory (ROM) and/or other static storage device coupled to the processor bus 412 for storing static information and instructions for the processors 402-406. The system outlined in FIG. 4 is but one possible example of a computer system that may employ or be configured in accordance with aspects of the present disclosure.

According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. In alternative embodiments, circuitry may be used in place of or in combination with the software instructions. Thus, embodiments of the present disclosure may include both hardware and software components.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in any applicable flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in any flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings.

The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices.

The term “local area network” or “LAN” at least in some examples refers to a network of devices, whether indoors or outdoors, covering a limited area or a relatively small geographic area (e.g., within a building or a campus). The term “wireless local area network”, “wireless LAN”, or “WLAN” at least in some examples refers to a LAN that involves wireless communications.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method for automatically provisioning intelligent electronic devices (IEDs) in a network, the method comprising:
identifying, by a device management system, basic details of a containerized IED included in a discovery packet auto-published by the containerized IED, wherein the containerized IED hosts one or more applications in containers or virtual machines in the network;
determining, by the device management system, based on the basic details, that the containerized IED is running and reachable in the network;
identifying autonomously, by the device management system, based on the basic details, a secure login mechanism for the containerized IED;
sending, by the device management system, a secure connection request to the containerized IED based on the secure login mechanism;
receiving automatically, by the device management system, based on a successful secure login authentication, advanced details of the containerized IED provided by the containerized IED;
identifying, by the device management system, based on the advanced details, an upgrade available to one or more applications already running and one or more new applications available to be ported in the containerized IED;
instructing, by the device management system, a backup virtual machine or container of the one or more applications already running to run an application during an upgrade;
sending, by the device management system, the upgrade for the application to a primary container in the containerized IED; and
monitoring, by the device management system, a successful upgradation and running of the upgraded application in the containerized IED;
instructing, by the device management system, the primary container to start running the upgraded application and to upgrade the backup virtual machine or container with a new application version simultaneously in the containerized IED;
identifying, by the device management system, based on the advanced details, one or more available containers with which to host the one or more new applications;
instructing, by the device management system, the one or more available containers to port the one or more new applications in a specific container of the containerized IED;
monitoring, by the device management system, a successful porting and running of the one or more new applications without any errors in the specific container of the containerized IED;
instructing by the device management system, to establish communication links of specific container with required other containers and network interfaces of the containerized IED; and
monitoring continuously, by the device management system, new upgrades and applications available for each containerized IED present in the network.

2. The method of claim 1, further comprising:
sending, by the device management system, a broadcast request for information from containerized IEDs running in the network,
wherein the containerized IED provides the basic details based on the broadcast request.

3. The method of claim 1, wherein the basic details are encrypted in a header of the discovery packet.

4. The method of claim 1, wherein the basic details comprise at least one of a medium access control address of the containerized IED, a serial number of the containerized IED, an Internet Protocol address of the containerized IED, a device type of the containerized IED, or another unique identifier of the containerized IED.

5. The method of claim 1, wherein the advanced details are indicative of applications run by the containerized IED, algorithms run by the containerized IED, application and algorithm versions, inter-dependencies between containers of the containerized IED, container dependencies on memory access resources of the containerized IED, available containers of the containerized IED with which to load new applications, communication protocols between containers of the containerized IEDs, and client subscriptions to IED containers.

6. The method of claim 1, further comprising:
automatically updating the application in the containerized IED based on an upgrade version availability and an operator setting if enabled; and
automatically porting the new application in the containerized IED based on the upgrade version availability and the operator setting if enabled.

7. The method of claim 1, further comprising:
disabling the backup virtual machine or container upon completion of the upgrade in the primary container.

8. The method of claim 1, further comprising:
determining an impact of the upgrade on IED operations; and
determining to provide the upgrade only after an operator approval, based on a severity of the impact.

9. An asset management system for a grid network, the asset management system comprising memory coupled to at least one processor, wherein the at least one processor is configured to:
identify basic details of a containerized IED included in a discovery packet auto-published by the containerized IED, wherein the containerized IED hosts one or more applications in containers or virtual machines in the network;
determine, based on the basic details, that the containerized IED is running and reachable in the network;
identify autonomously, based on the basic details, a secure login mechanism for the containerized IED;
send a secure login request to the containerized IED based on the secure login mechanism;
receive automatically, based on a successful secure login authentication, advanced details of the containerized IED provided by the containerized IED;
identify, based on the advanced details, an upgrade available to one or more applications already running and one or more new applications available to be ported in the containerized IED;
instruct a backup virtual machine or container of the one or more applications already running to run an application during an upgrade;
send the upgrade for the application to a primary container in the containerized IED;
monitor a successful upgradation and running of the upgraded application in the containerized IED;
instruct the primary container to start running the upgraded application and to upgrade the backup virtual machine or container with a new application version simultaneously in the containerized IED;
identify, based on the advanced details, one or more available containers with which to host the one or more new applications;
instruct the one or more available containers to port the one or more new applications in a specific container of the containerized IED;
monitor a successful porting and running of the one or more new applications without any errors in the specific container of the containerized IED;
instruct to establish communication links of specific container with required other containers and network interfaces of the containerized IED; and
monitor, continuously, new upgrades and applications available for each containerized IED present in the network.

10. The system of claim 9, wherein the at least one processor is further configured to:
send a broadcast request for information from containerized IEDs running in the network,
wherein the containerized IED provides the basic details based on the broadcast request.

11. The system of claim 9, wherein the basic details are encrypted in a header of the discovery packet.

12. The system of claim 9, wherein the basic details comprise at least one of a medium access control address of the containerized IED, a serial number of the containerized IED, an Internet Protocol address of the containerized IED, a device type of the containerized IED, or another unique identifier of the containerized IED.

13. The system of claim 9, wherein the advanced details are indicative of applications run by the containerized IED, algorithms run by the containerized IED, application and algorithm versions, inter-dependencies between containers of the containerized IED, container dependencies on memory access resources of the containerized IED, available containers of the containerized IED with which to load new applications, communication protocols between containers of the containerized IEDs, and client subscriptions to IED containers.

14. The system of claim 9, wherein at least one processor of the containerized IED is configured to:
automatically update the application at the containerized IED based on an upgrade version availability and an operator setting when enabled; and
automatically port the new application in the containerized IED based on the upgrade version availability and the operator setting.

15. The system of claim 9, wherein the at least one processor is further configured to:
disable the backup virtual machine or container upon completion of the upgrade in the primary container.

16. The system of claim 9, wherein the at least one processor is further configured to:
determine an impact of the upgrade on IED operations; and
determine to provide the upgrade only after an operator approval based on a severity of the impact.

17. A non-transitory computer-readable medium storing instructions that, when executed by at least one processor of an asset management system for a grid network, cause the at least one processor to:
identify basic details of a containerized intelligent electronic device (IED) included in a discovery packet auto-published by the containerized IED, wherein the containerized IED hosts one or more applications in containers or virtual machines in the network;
determine, based on the basic details, that the containerized IED is running and reachable in the network;
identify autonomously, based on the basic details, a secure login mechanism for the containerized IED;
send a secure login request to the containerized IED based on the secure login mechanism;
receive automatically, based on a successful secure login authentication, advanced details of the containerized IED provided by the containerized IED;
identify, based on the advanced details, an upgrade available to one or more applications already running and one or more new applications available to be ported in the containerized IED;
instruct a backup virtual machine or container of the one or more applications already running to run an application during an upgrade;
send the upgrade for the application to a primary container in the containerized IED;
monitor a successful upgradation and running of the upgraded application in the containerized IED;
instruct the primary container to start running the upgraded application and to upgrade the backup virtual machine or container with a new application version simultaneously in the containerized IED;
identify, based on the advanced details, one or more available containers with which to host the one or more new applications;
instruct the one or more available containers to port the one or more new applications in a specific container of the containerized IED;
monitor a successful porting and running of the one or more new applications without any errors in the specific container of the containerized IED;
instruct to establish communication links of specific container with required other containers and network interfaces of the containerized IED; and
monitor, continuously, new upgrades and applications available for each containerized IED present in the network.

18. The non-transitory computer-readable medium of claim 17, wherein execution of the instructions further causes the at least one processor to:
send a broadcast request for information from containerized IEDs running in the network,
wherein the containerized IED provides the basic details based on the broadcast request.

19. The non-transitory computer-readable medium of claim 17, wherein the basic details are encrypted in a header of the discovery packet.

20. The non-transitory computer-readable medium of claim 17, wherein the basic details comprise at least one of a medium access control address of the containerized IED, a serial number of the containerized IED, an Internet Protocol address of the containerized IED, a device type of the containerized IED, or another unique identifier of the containerized IED.
